(19) United States
(12) Patent Application Publication
(10) Pub. No.: US 2013/0161935 A1
(43) Pub. Date: Jun. 27, 2013

(54) ADJUSTABLE SPLASH GUARD ASSEMBLY AND METHOD

(71) Applicants: Douglas Kenneth Ward, Toronto (CA); Ken Lott, Whitby (CA); Edward Kish, Scarborough (CA); Ken Miller, Scarborough (CA)

(72) Inventors: Douglas Kenneth Ward, Toronto (CA); Ken Lott, Whitby (CA); Edward Kish, Scarborough (CA); Ken Miller, Scarborough (CA)

(73) Assignee: POWERFLOW, INC., Buffalo, NY (US)

(21) Appl. No.: 13/334,794

(22) Filed: Dec. 22, 2011

(51) Int. Cl. B62D 25/18

(52) U.S. Cl. 280/851

(57) ABSTRACT

An adjustable splash guard assembly (50) for attachment to a vehicle (10) having a substantially planer mud flap (52) defined by first and second sides (60, 62). The adjustable splash guard assembly (50) further includes an adjustable cover (54) having an inside panel (86) and an outside panel (88) forming a pocket (90) therebetween, and an adjustable assembly (200) comprising a pivoting connection (202) formed by a first fastener (210) coupling the inside panel (86) of the adjustable cover (54) to the mud flap (52), the adjustable assembly (200) further comprises a selectively pivoting connection formed by a second fastener (216) coupled to the inside panel (86) of the adjustable cover (54), and a plurality of variable positioning apertures (204) located through the mud flap (52).

### TECHNICAL FIELD

The present disclosure relates to an adjustable splash guard assembly and method, more specifically, to an adjustable splash guard assembly and method of installation to any number of body profiles associated with different vehicle body styles and/or options.

### BACKGROUND

Splash guards are generally mounted at the back region of a front and/or rear wheel well of a vehicle, and particularly a motor vehicle such as a car, truck, bus, motorcycle, all-terrain vehicle, motor home, camper, and the like (hereinafter collectively “vehicle”). Traditionally, splash guards were mounted to a vehicle panel or structure forming part of the wheel well opening, such as, for example, a vehicle fender. Some conventional splash guards and their method of attachment are further shown and described in U.S. Pat. Nos. D415,460, 5,722,690, and 4,079,938, all of which are incorporated herein by reference in their entireties.

The wheel well opening defined by a vehicle fender typically includes a flanged lip or rolled edge that generally extends from an exterior or outer surface of the fender inwardly in a direction toward the centerline of the vehicle. The vehicle fender typically comprises in addition to the wheel well, a body panel fascia that may or may not be integrated into one or more of a bumper, ground effect foil, and rocker panel. The splash guard was typically affixed to the flanged lip by a plurality of threaded fasteners.

Today, many vehicles designs are based on so-called global vehicle platforms. A global vehicle platform typically refers to use of a single vehicle platform as the base or platform for the manufacturing of a number of vehicle models which varying interior and exterior designs, engine/power train options, etc. Typically, the global vehicle platform includes a common underbody, frame and suspension components.

The global vehicle platform concept allows for manufacturing efficiencies and standardization resulting from producing a single, high volume platform that may be utilized across multiple vehicle models and even shared by multiple cooperating manufacturers. At the same time, a global vehicle platform advantageously supports a variety of exterior/interior design options, including variations in body panels, bumpers, ground effects, and the like. Such choices allow the vehicles to be customized for particular countries or regions that the vehicles will be marketed to and/or to provide more options to the consumers while minimizing manufacturing costs.

In addition to consumer options that create variations in body panels, bumpers, ground effects, etc., is the fact that various countries or regions may mandate different vehicle standards required for any vehicle sold into that country or region in terms of safety, emissions, ability to recycle vehicle components, etc. For a vehicle sold, for example, into the European market it may require a rear bumper fascia that extends forwardly from the rear of the vehicle and forms a lower portion of the vehicle wheel well opening. The rear bumper fascia, thus, comprises a vehicle panel that defines the mounting structure or mounting region for mounting of rear wheel splash guards. Such bumper configuration may not be required in the U.S. or aesthetically desirable to the consumer based on geographical differences.

Conventional splash guards are typically a single piece of molded plastic or rubber designed to match the profile of the specific vehicle. A different mold is typically required when using conventional splash guards for the same vehicle if different consumer options or variations in vehicle standards are employed. Recent increases in the desire to provide consumers with more options and variations in vehicles standards such as safety, increase the number of conventional splash guards molded to meet the profile of the body panels. This increases the number of molds required and the costs associated with each splash guard. In addition, an increase in cost is experienced with the large number of splash guard part numbers needing to be managed and inventoried for each vehicle based on the number of consumer options or variations in vehicle standards.

As stated above, conventional splash guards are designed to fit a specific a vehicle's body panel fascia, bumper, air foil, rocker panel, or any combination thereof (hereinafter collectively or individual “body profile”). A large limitation of a conventional design occurs when a vehicle has different body profiles based on different customer options or safety features. As a result, the intended splash guard may not fit the vehicle as intended between the different features and options. For example, when a vehicle 1 has option or design comprising a small fender panel curvature 2, as illustrated in FIG. 1, the conventional splash guard 4 desirably remains substantially parallel with the tire 5 downward facing as indicated by arrow “A”. When the options or features of that same vehicle result in a different body profile comprising a large fender panel curvature 3, as illustrated in FIG. 2, the same conventional splash guard 4 when attached undesirably rolls under the vehicle 1 as indicated by arrow B. FIG. 2 illustrates that when the same the conventional splash guard 4 is used on different vehicles or body profiles of the same vehicle, it may not fit or perform property. That is, conventional splash guards are undesirably limited to the shape of the vehicle body profile in order to function properly.

### SUMMARY

One example embodiment of the present disclosure comprises an adjustable splash guard assembly for attachment to a vehicle having a substantially planer mud flap defined by first and second sides. The adjustable splash guard assembly further includes an adjustable cover having an inside panel and an outside panel forming a pocket therebetween, and an adjustable assembly comprising a pivoting connection formed by a first fastener coupling the inside panel of the adjustable cover to the mud flap, the adjustable assembly further comprises a selectively pivoting connection formed by a second fastener, locator opening in the inside panel of the adjustable cover, and a plurality of variable positioning apertures located in the mud flap.

Another example embodiment of the present disclosure comprises an adjustable splash guard assembly for attaching to a vehicle, the adjustable splash guard assembly comprises a substantially planer mud flap defined by first and second sides for protecting the surface of a body portion of a vehicle from road and tire debris, the mud flap is formed from a first material having a first durometer. The adjustable splash guard assembly also comprises an adjustable cover having an inside panel and an outside panel forming a pocket therebetween, wherein the inside panel is engaged with one of the first and second sides of the mud flap and the outside panel is engaged with a surface of a body portion of a vehicle. The adjustable cover is formed from a second material having a second durometer. The adjustable splash guard assembly yet also comprises an adjustable assembly having a pivoting connection formed by a first fastener coupling a pivot opening in the inside panel of a first end of the adjustable cover to a corresponding pivot hole the mud flap, the adjustable assembly further comprises a selectively pivoting connection formed by a second fastener, locator opening in a second end of the inside panel of the adjustable cover, and a plurality of variable positioning apertures located through the mud flap, such that the second fastener passes through the locator opening and one of the plurality of variable positioning apertures to form a seamless engagement with a body portion of a vehicle.

Whilst another example embodiment of the present disclosure comprises a method of securing an adjustable splash guard to a vehicle. The method comprises the steps of securing a first end of an adjustable cover having an inside panel and an outside panel forming a pocket therebetween to a substantially planer mud flap defined by first and second sides at a pivot point using a first fastener and rotatably adjusting a second end of the adjustable cover about the pivot point to align a locating opening in the inside panel of the adjustable cover to a select one of a plurality of variable positioning apertures located through the mud flap with a second fastener.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 illustrates a conventional splash guard mounted to a vehicle having a first body profile;

FIG. 2 illustrates the same conventional splash guard of FIG. 1 mounted to either a different vehicle or the same vehicle having a different body profile;

FIG. 3 is a schematic perspective view of a vehicle having a rear bumper fascia forming part of a rear wheel well opening for supporting a rear wheel splash guard;

FIG. 3A is a schematic perspective view of a portion of a rear wheel well opening of the vehicle of FIG. 3 showing the forward projecting edge portion of the rear bumper fascia and a recessed wheel well molding;

FIG. 4 is a perspective view of an adjustable splash guard assembly constructed in accordance with one example embodiment of the present disclosure;

FIG. 5 is a second perspective view of the adjustable splash guard assembly of FIG. 4;

FIG. 6 is a schematic exploded perspective view of the adjustable splash guard assembly of FIG. 4;

FIG. 7 is an elevated front view of a mud flap constructed in accordance to one example embodiment of the present disclosure;

FIG. 8 is an elevated side view of the mud flap of FIG. 7;

FIG. 9 is a elevated front view of an adjustable cover constructed in accordance with one example embodiment of the present disclosure;

FIG. 10 is a first perspective view of the adjustable cover of FIG. 9;

FIG. 11 is a second perspective view of the adjustable cover of FIG. 9;

FIG. 12 is a elevated first assembly view of an adjustable splash guard constructed in accordance with one example embodiment of the present disclosure;

FIG. 13 is a elevated second assembly view of the adjustable splash guard of FIG. 12;

FIG. 14 illustrates an adjustable splash guard assembly constructed in accordance with the present disclosure mounted to a vehicle having a first body profile;

FIG. 15 illustrates the adjustable splash guard assembly of FIG. 14 mounted to a vehicle having a second body profile;

FIG. 16 illustrates a pivot arrangement constructed in accordance with one example embodiment of the present disclosure;

FIG. 17A illustrates an adjustment assembly between the mud flap and adjustable cover in accordance with one example embodiment of the present disclosure;

FIG. 17B illustrates an adjustment assembly between the mud flap and adjustable cover in accordance with another example embodiment of the present disclosure;

FIG. 18 illustrates a perspective view an adjustable splash guard assembly constructed in accordance with one example embodiment of the present disclosure secured to a vehicle; and

FIG. 19 is a cross sectional view of FIG. 18 along section lines 19-19.

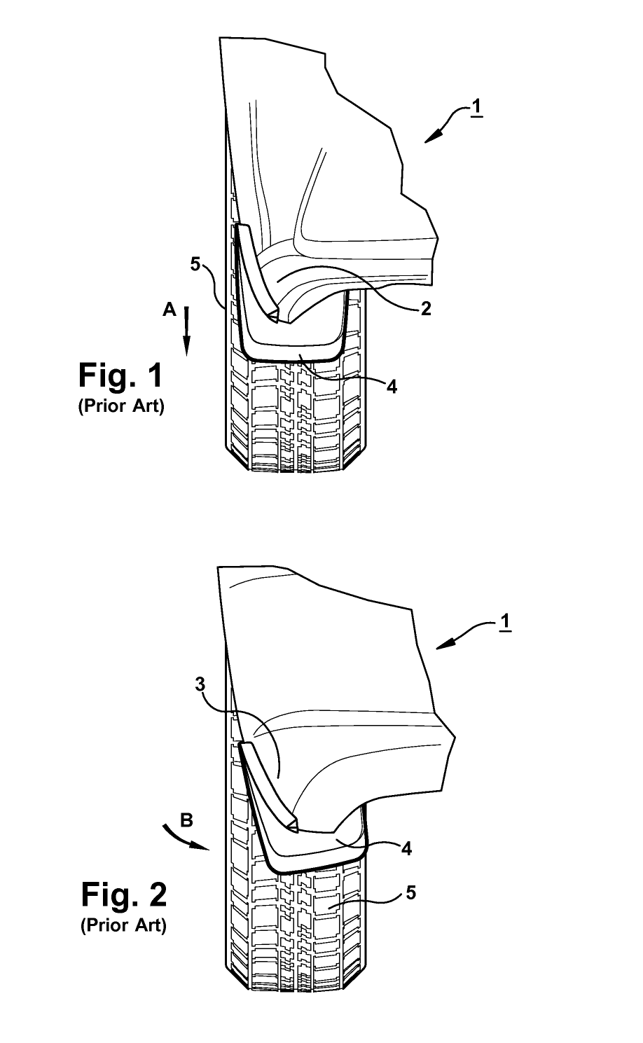

### DETAILED DESCRIPTION

Referring now to the figures generally wherein like numbered features shown therein refer to like elements throughout unless otherwise noted. The present disclosure relates generally to an adjustable splash guard assembly and method, more specifically, to an adjustable splash guard assembly and method for installation to any number of body profiles associated with different vehicle body styles and/or options.

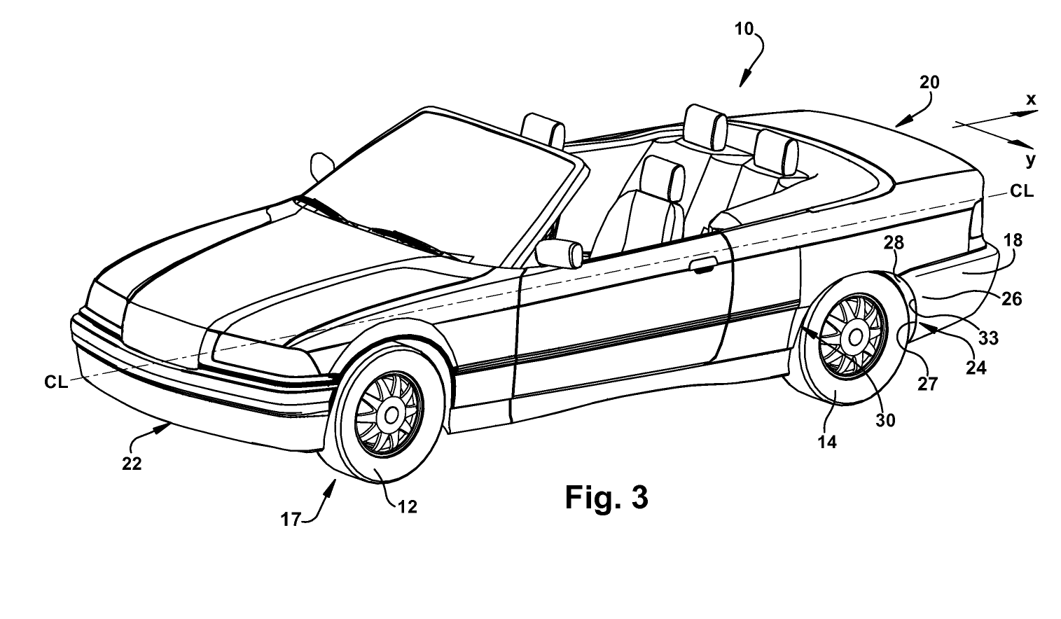

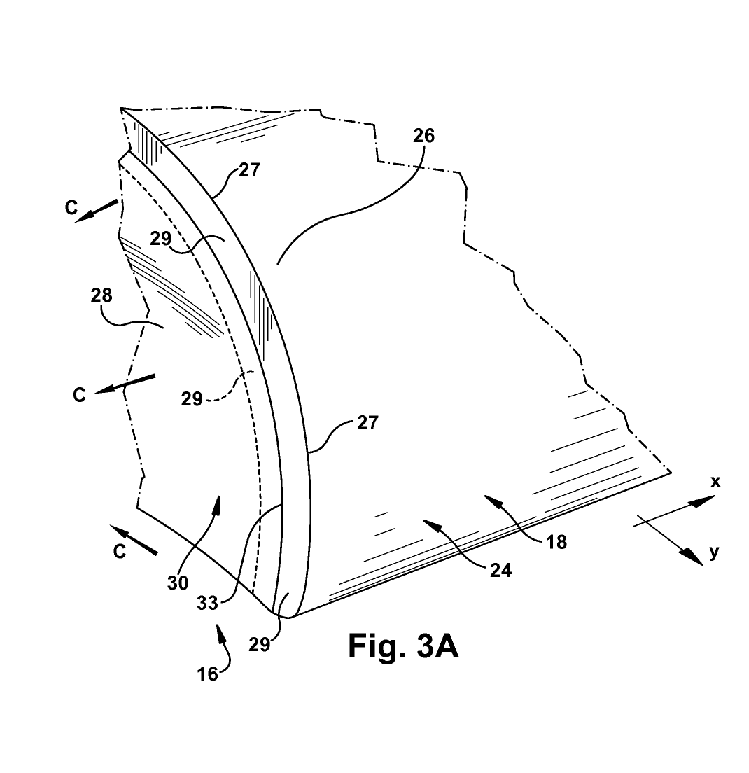

Turning to the drawings, FIG. 3 schematically depicts a vehicle 10 having a vehicle centerline CL and front and rear wheels 12, 14. The rear wheel 14 is partially surrounded by a rear wheel well 16. A portion of the rear wheel well 16 is defined by a rear bumper fascia 18 that wraps around a rear end 20 of the vehicle 10 (typically defined by a rear bumper—not shown) and extends in a forward direction F toward a front end 22 of the vehicle 10. A portion of a rear wheel well 16 is defined by a forward, peripheral portion 24 of the rear bumper fascia 18.

As can best be seen in FIGS. 3A, 18, and 19, the forward, peripheral portion 24 of the rear bumper fascia 18 defines a body profile or outer surface 26 of the rear wheel well 16, while a rear wheel well molding 28 defines an interior region 30 of the rear wheel well 16. The outer surface 26 bends transversely inward in the direction of arrows C at corner perimeter 27 forming an inner mounting flange 29 covered partially the rear wheel well molding 28.

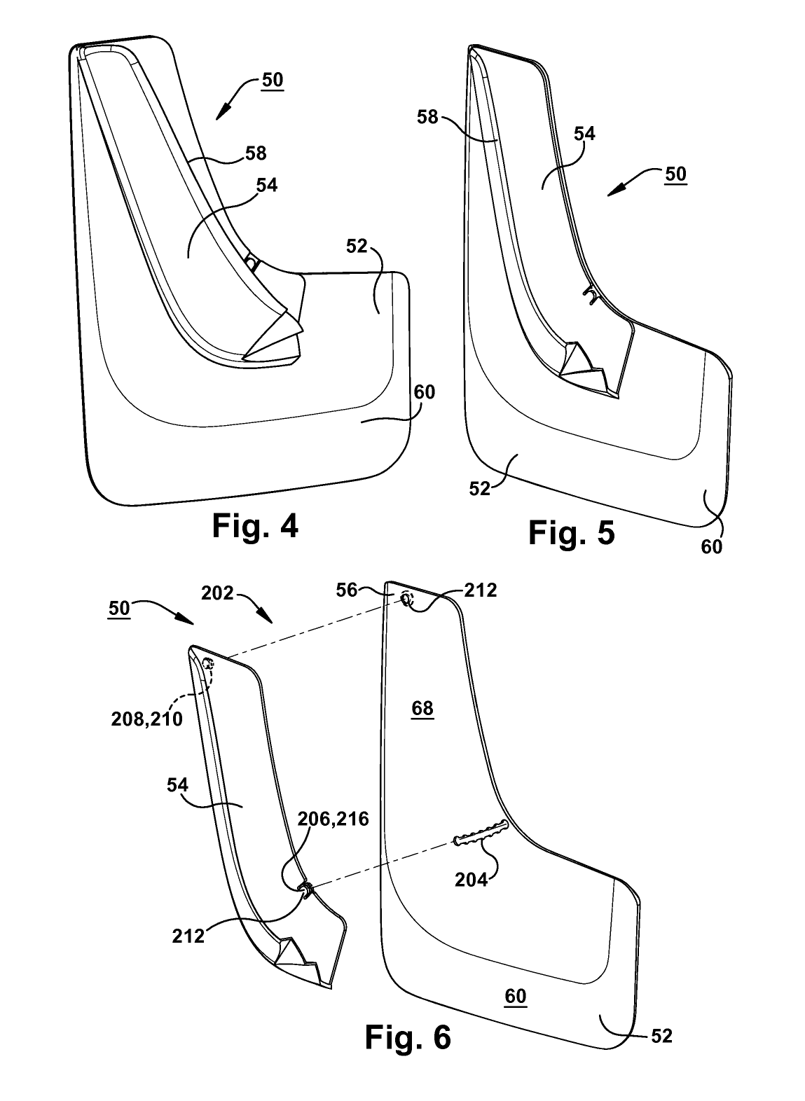

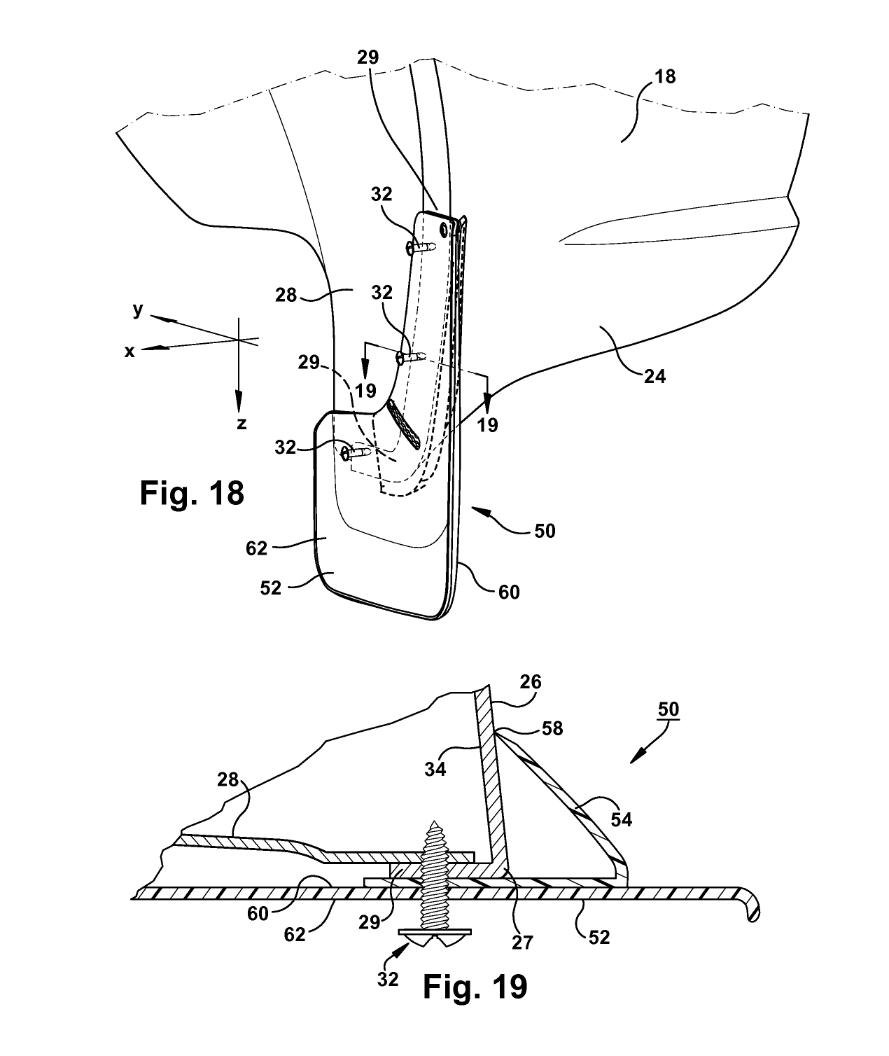

The wheel well molding 28 projects over the inner mounting flange 29 at an edge perimeter 33. For purposes of mounting an adjustable splash guard assembly 50 (see FIGS. 4-6) to the rear wheel well 16, the inner mounting flange 29 is presented to the installer of the adjustable splash guard assembly 50. The adjustable splash guard assembly 50 is then secured to the inner mounting flange 29 using fasteners 32 as further discussed below in detail and shown in FIGS. 18 and 19. In one example embodiment, the fasteners 32 are self-tapping screws.

While a rear wheel well 16 of a vehicle 10 is shown in FIG. 3A, it should be appreciated by one of ordinary skill in the art that the front wheel well 17, as shown in FIG. 3, would have a similar assembly and construction. Therefore, the adjustable splash guard assembly 50 of the present disclosure could be applied to either the front 17, rear 16, or both wheel well on both sides of the vehicle 10.

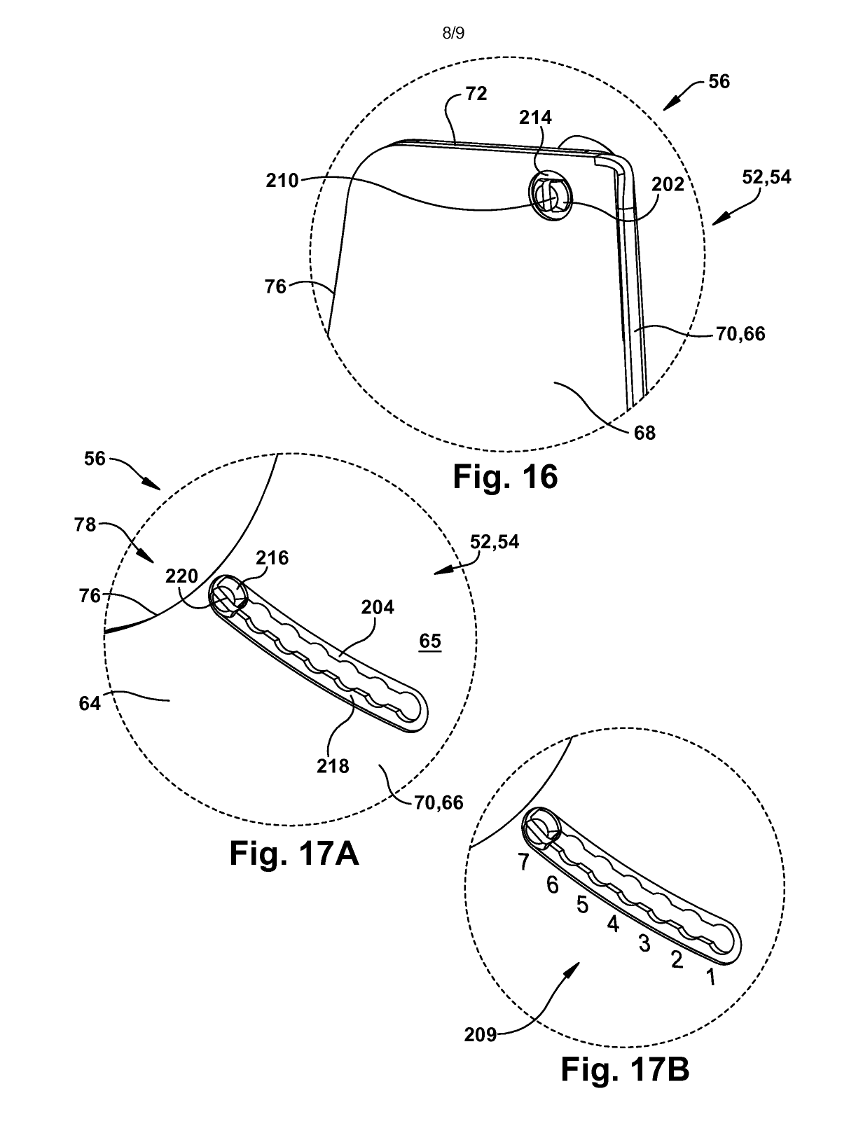

Illustrated in FIGS. 4-6 is an adjustable splash guard assembly 50 constructed in accordance with one example embodiment of the present disclosure. The adjustable splash guard assembly 50 comprises a mud flap 52 rotatably connected to an adjustable cover 54. The adjustable splash guard assembly 50 advantageously allows the adjustable cover 54 to be selectively positioned on the mud flap 52 to fit the body profile of a number of vehicles or options to the same vehicle. This two-piece construction of the adjustable splash guard assembly 50 comprising both a separately molded mud flap 52 and adjustable cover 54 and their pivoting arrangement 56 (see FIGS. 16-17A) forming the rotatable connection there between increases the number and variety of the vehicles and/or options that the splash guard could be properly attached.

In one example embodiment, the adjustable splash guard assembly 50 comprising both the mud flap 52 and adjustable cover 54 are made from a polymeric material. In another example embodiment, the mud flap 52 is molded from a material having a relatively higher durometer than the material forming the adjustable cover 54. In yet another example embodiment, the mud flap 52 is molded from a polymeric material such as polypropylene or thermoplastic olefin having a flex modulus of 600 Mpa or greater, rigid enough to withstand debris from the vehicle tires and road.

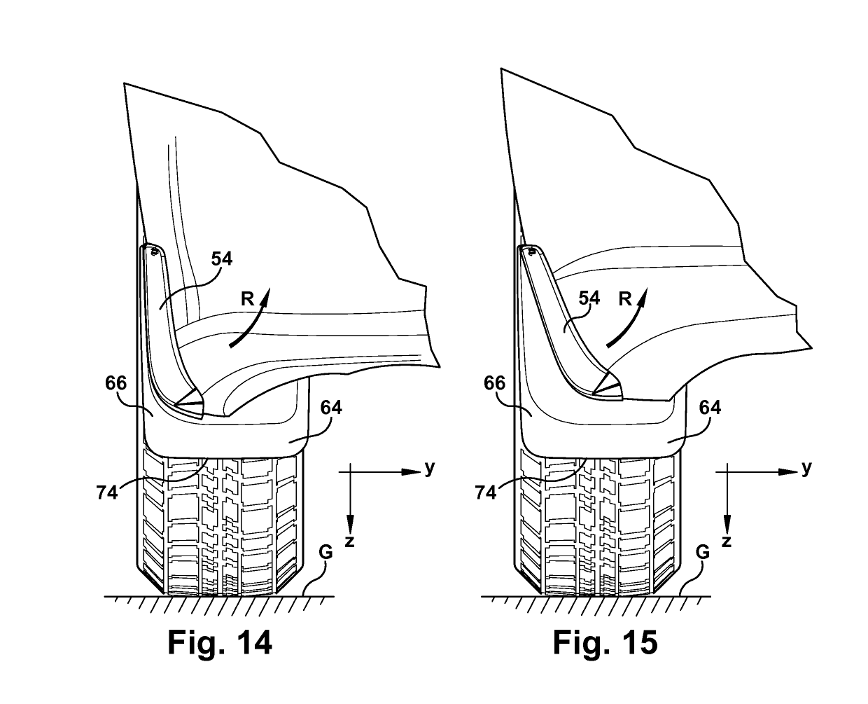

In one example embodiment, the adjustable cover 54 is molded from a more pliable material than the mud flap 52, allowing the adjustable cover to pivot about the pivoting arrangement 56 so that a contacting edge 58 conforms to the surface of the harder material forming the body profile, such as the bumper fascia 18, rocker panel, air foil or any combination thereof as illustrated in FIGS. 14, 15 18 and 19. In yet another example embodiment, the adjustable cover 54 is molded from a polymeric material such as thermoplastic rubber or linear low-density polyethylene having a flex modulus of approximately 550 Mpa, flexible enough to conform to the body profile of the vehicle 10 without allowing a gap therebetween. In the illustrated example embodiment, the mud flap 52 and adjustable cover 54 have a thickness “t” (see FIG. 8) between three-sixteenths ( 3/16″) and one-quarter of one inch (¼″).

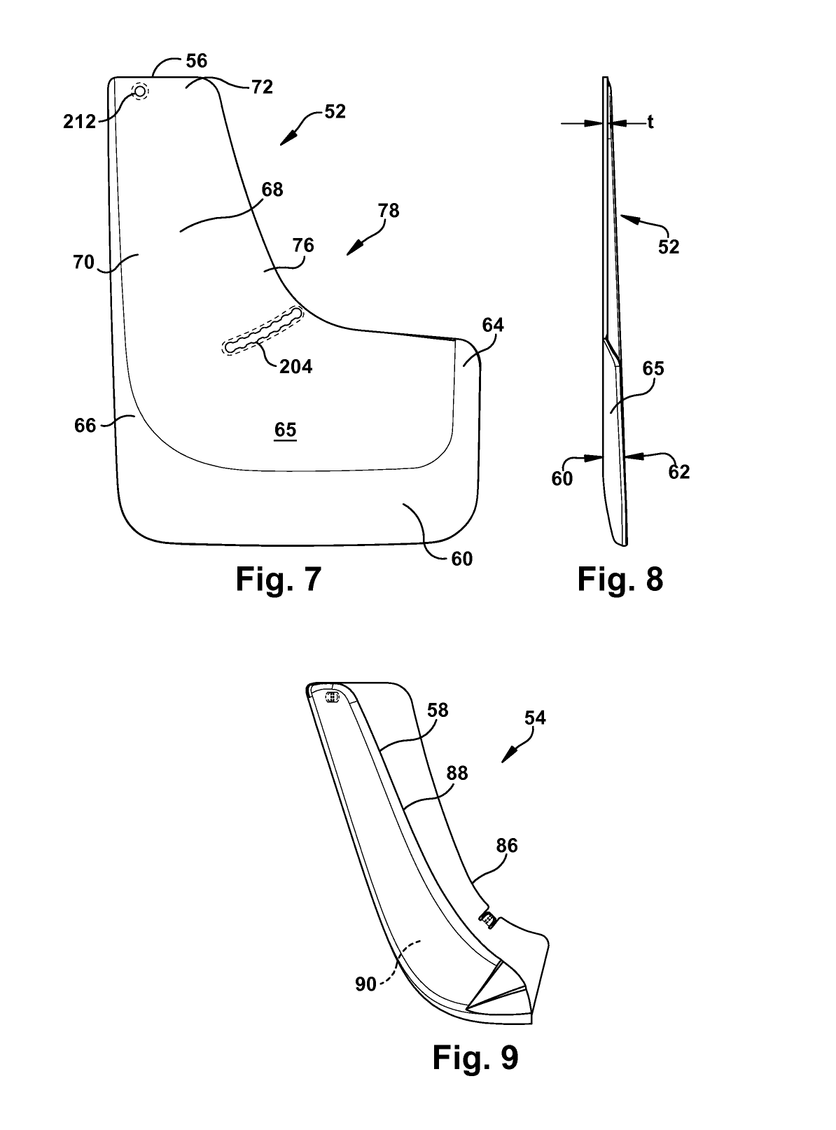

FIGS. 7 and 8 illustrate the mud flap 52 separated from the adjustable cover 54. The mud flap 52 includes two substantially planar sides, designated by a rear side 60 and a front side 62. The rear side 60 faces the rear of the vehicle 10, while the front side 62 faces the front of the vehicle and is exposed to the inner wheel wells 16, 17.

It should be appreciated that a vehicle will have a left and right mud flap 52 and adjustable cover 54 identical in geometrical configuration except being the mirror image of each other. For example, the mud flap 52 in FIG. 4 FIG. 18 are right-side mud flaps that are attached to the passenger side of a vehicle 10 that is left-hand drive. The mud flap 52 comprises a body portion 65 substantially rectangular in shape having an inside end 64 and outside end 66. The inside end 64 extends laterally toward the inside of the wheel wells 16, 17 in the direction of the y-axis (see FIGS. 3, 3A and 18) when attached to the vehicle 10. The outside end 66 vertically extends in the direction of the z-axis, from the body portion 64 to a support region 68 a top 72 along an outer profile 70 of the mud flap.

Located opposite the top end 72 below the support region 68 and body portion 65 is a bottom end 74. An arcuate support section 76 comprises a radius 78 between the body portion 65 and support region 68. The arcuate support section 76 is shaped to substantially align with the inner mounting flange 29 of the wheel wells 16, 17 during assembly to the vehicle 10 as illustrated in FIG. 18. A plurality of fasteners 32 pass through the mud flap 52, adjustable cover, inner mounting flange 29, and wheel well molding 28 as illustrated in FIGS. 18 and 19.

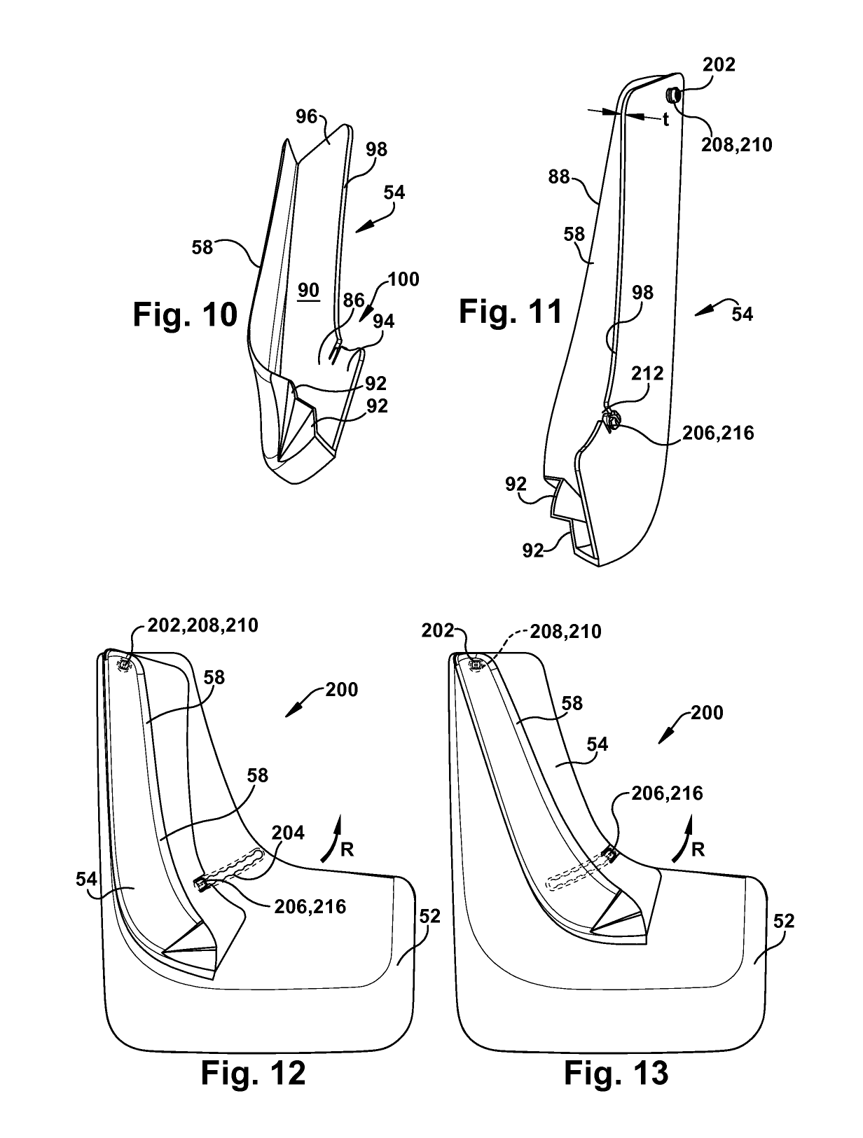

Turing now to FIGS. 9-11, the adjustable cover 54 is shown in accordance to one example embodiment of the present disclosure. The adjustable cover 54 comprises an inside panel 86 and outside panel 88 forming an expandable arcuate pocket 90 therebetween. The inside panel attaches to the rear side 60 of the mud flap as shown in FIGS. 18 and 6 and as further described below. The outside panel 88 comprises a plurality of folds or bellows 92 that allow the cover 54 to expand as necessary over the body profile 26, allowing the contacting edge 58 to engage the vehicle.

The adjustable cover 54 also comprises a bottom edge 94 and top edge 96. Extending between the bottom edge 94 and top edge 96 along the inside panel is arcuate support region 98 defining a radius 100. Along the outside panel 88, the contacting edge 58 spans from the bottom edge 94 to the top edge 96.

Illustrated in FIGS. 12-13 and 16-17 is an adjustable assembly 200 associated with a splash guard 50 as constructed in accordance with one example embodiment of the present disclosure. The adjustable assembly 200 advantageously allows the contacting edge 58 to make a seamless or “gap free” engagement with a plurality of different body profiles 26 of one or several different types of vehicles 10. That is, the adjustable assembly 200 allows the bottom end 74 of the mud flap 52 to remain substantially parallel with the ground G as illustrated by the two different vehicles 10 having different body profiles in FIGS. 14 and 15. This desirably reduces the number of part numbers and inventory required, since the splash guard 50 having the adjustable assembly 200 can properly attach to so many different body profiles 26.

The adjustable assembly 200 comprises the two separate piece construction between the mud flap 52 and adjustable cover 54. By way of the two-piece construction, such design also advantageously allows the mud flap 52 and adjustable cover 54 to be molded from two different materials, reducing the material costs of the splash guard 50. That is, the flexible and typically more expensive material required in the entire single mold of a conventional splash guard can now be reduced to only being used in the adjustable covers 54. The two-piece design therefore, reduces the need of the more expensive material in the mud flap 52.

The adjustable assembly 200 further comprises the pivoting arrangement 56 having a pivot connection 202 located in, and through the mud flap 52 and adjustable cover 54, variable positioning apertures 204 located in the mud flap 52, first protrusion 216 molded into and projecting from the back side of the adjustable cover 54. As illustrated in FIGS. 6 and 16, the adjustable cover 54 is first attached to the mud flap 52 by the positioning of a second protrusion 210 molded into and projecting from the back side of the adjustable cover through the pivot opening 208 found on the inside panel 86 and within a pivot hole 212 through the support region 68 of the mud flap. In an alternative example embodiment, the first and second protrusions 206, 210 are independently attached rotatable fasteners or pins that pass through corresponding openings on the adjustable cover and mud flap.

Located within the front side 62 is a recess or counter bore 214 to support the second protrusion 210 so that it does not protrude too far out from the guard envelop formed by the recess. The recess 214 will reassure the durability of the second protrusion 210. In one example embodiment, the first and second protrusions 206, 210 are rivets molded into the mud flap 52.

Once the protrusion 210 secures the adjustable cover 54 to the mud flap 52, the adjustable cover can be rotatably selectively connected at a desired location to seamlessly engage the body profile 26 of a number of different vehicles 10. Specifically, the adjustable cover rotates about the pivot connection 202 in the direction of arrow “R” (see FIGS. 12-13, 14-15) until obtaining the desired position against a particular vehicle 10. At this point, the first protrusion 216 passes through a corresponding one of the variable positioning apertures 204. In one example embodiment, the first protrusion 216 is a rivet that snaps into position of the splash guard 50. The protrusion 216 has the retention ability to snap itself into the desired location and is capable of holding the adjustable cover 54 in place until the entire splash guard 50 is secured to the wheel well 16, 17 by fasteners 32 passing through the splash guard 50 and inner mounting flange 29 as described and shown in FIGS. 18-19.

As illustrated in FIG. 17A, the front side 62 of the mud flap 52 includes a recess 218 to support the protrusion 216 so that it does not protrude too far out from the guard envelop formed by the recess. The recess 218 will reassure the durability of the protrusion 216. In one example embodiment, the protrusion 216 is a rivet comprising a slot 220 molded into the rivet, allowing the removal of the rivet by its collapsing when the sides are pinched together, reducing the rivets head diameter, thus permitting passage through the variable aperture 204.

During installation, the user first installs the adjustable cover 54 to the mud flap 52 via second protrusion 210 at pivot connection 202. At this point, the adjustable splash guard 50 can be positioned within the wheel well 16, 17 and the adjustable cover 52 is rotated and fitted as indicated by arrows R against the particular body profile 26 of the selected vehicle 10. The fit would allow for a seamless engagement between the contact edge 58 of the adjustable cover 54 and body profile 26. The locator opening 206 and corresponding variable positioning apertures 204 are noted, and as the splash guard is moved away, the user places the first protrusion through the locator opening and corresponding aperture 204 of the mud flap. For mass installation, for example at an automotive assembly plant, the desired aperture of the apertures 204 could be marked and charted for each different vehicle and/or option to avoid manual measuring by the installer by the numbers 209 illustrated in FIG. 17B.

Once the two piece assembly of the mud flap 52 and adjustable cover 54 are attached by both protrusions 210, 216 to the desired fitted position, the splash guard 50 can be attached by fasteners 32 as shown and described in FIGS. 18 and 19. This assembly allows advantageously the adjustable splash guard 50 and its bottom end 74 to remain parallel with the ground G, protecting the car and body profile 26 from road and tire debris while permitting the adjustable cover to be seamless and tight against the body profile of several different vehicles and/or options.

As used herein, terms of orientation and/or direction such as upward, downward, forward, rearward, upper, lower, inward, outward, inwardly, outwardly, horizontal, horizontally, vertical, vertically, distal, proximal, axially, radially, etc., are provided for convenience purposes and relate generally to the orientation shown in the Figures and/or discussed in the Detailed Description. Such orientation/direction terms are not intended to limit the scope of the present disclosure, this application and the invention or inventions described therein, or the claims appended hereto.

What have been described above are examples of the present disclosure. It is, of course, not possible to describe every conceivable combination of components, assemblies, or methodologies for purposes of describing the present disclosure, but one of ordinary skill in the art will recognize that many further combinations and permutations of the present disclosure are possible. Accordingly, the present disclosure is intended to embrace all such alterations, modifications, and variations that fall within the spirit and scope of the appended claims.

1. An adjustable splash guard assembly comprising:
a substantially planer mud flap defined by first and second sides;
an adjustable cover having an inside panel and an outside panel forming a pocket therebetween;
an adjustable assembly comprising a pivoting connection formed by a first fastener coupling said inside panel of said adjustable cover to said mud flap, the adjustable assembly further comprising a selectively pivoting connection formed by a second fastener coupled to inside panel of said adjustable cover and a plurality of variable positioning apertures located through said mud flap, said plurality of variable Positioning apertures located within an elongated slot extending between said first and second sides of said mud flap, the adjustable cover being configured to rotate about the pivot connection formed by the first fastener in an axial direction towards a portion of a vehicle.

2. The adjustable splash guard of claim 1 wherein said plurality of variable positioning apertures are adjacently arcuately located through said first and second sides of said mud flap.

3. The adjustable splash guard of claim 1 wherein said planer mud flap and said adjustable cover are made from different materials.

4. The adjustable splash guard of claim 1 wherein said planer mud flap is made from a material having a first durometer and said adjustable cover is made from a second material having a second durometer such that said first durometer of said first material is higher than the durometer of said second material.

5. The adjustable splash guard of claim 1 wherein said pivoting connection allows said adjustable cover having first and second ends to be selectively rotatably connected by said first fastener at said first end such that said second end rotates along one of first and second sides of said mud flap allowing said second fastener to pass through a selected one of said plurality of variable positioning apertures located through said mud flap.

6. The adjustable splash guard of claim 1 wherein said adjustable cover is rotatably coupled by said pivoting connection to one of said first and second sides, wherein said mud flap further comprising a recess located on the other of said first and second sides of said mud flap for protectively shrouding said first fastener.

7. The adjustable splash guard of claim 1 wherein said adjustable cover is rotatably coupled by said pivoting connection to one of said first and second sides, wherein said mud flap further comprising a recess located on the other of said first and second sides of said mud flap for protectively shrouding said second fastener.

8. The adjustable splash guard of claim 1 wherein said first fastener is molded into said adjustable cover.

9. The adjustable splash guard of claim 1 wherein said second fastener further comprises a slot at one end for removing said fastener from a secured position between said mud flap and adjustable cover.

10. The adjustable splash guard of claim 2 wherein said plurality of variable positioning apertures adjacently arcuately located through said first and second sides of said mud flap further comprises a center of said adjacently arcuately located positioning apertures defined by said pivoting connection.

11. An adjustable splash guard assembly for attaching to a vehicle, the adjustable splash guard assembly comprising:
a substantially planer mud flap defined by first and second sides for protecting the surface of a body portion of a vehicle from road and tire debris, the mud flap is formed from a first material having a first durometer;
an adjustable cover having an inside panel and an outside panel forming a pocket therebetween, wherein said inside panel is engaged with one of said first and second sides of said mud flap and said outside panel is engaged with a surface of a body portion of a vehicle, the adjustable cover is formed from a second material having a second durometer;
an adjustable assembly comprising a pivoting connection formed by a first fastener coupling said inside panel of a first end of said adjustable cover to a corresponding pivot hole in said mud flap, the adjustable assembly further comprising a selectively pivoting connection formed by a second fastener coupled to said inside panel of said adjustable cover, and a plurality of variable positioning apertures located through said mud flap, such that said second fastener passes through one of said plurality of variable positioning apertures to form a seamless engagement with a body portion of a vehicle, said plurality of variable positioning apertures located within an elongated slot extending between said first and second sides of said mud flap, the adjustable cover being configured to rotate about the pivot connection formed by the first fastener in an axial direction towards a portion of the vehicle.

12. The adjustable splash guard of claim 11 wherein said plurality of variable positioning apertures are adjacently arcuately located through said first and second sides of said mud flap.

13. The adjustable splash guard of claim 11 wherein said durometer of said first material is higher than the durometer of said second material.

14. The adjustable splash guard of claim 11 wherein said adjustable cover is rotatably coupled by said pivoting connection to one of said first and second sides, wherein said mud flap further comprising a recess located on the other of said first and second sides of said mud flap for protectively shrouding said first fastener.

15. The adjustable splash guard of claim 11 wherein said adjustable cover is rotatably coupled by said pivoting connection to one of said first and second sides, wherein said mud flap further comprising a recess located on the other of said first and second sides of said mud flap for protectively shrouding said second fastener.

16. The adjustable splash guard of claim 11 wherein said first fastener is molded into said adjustable cover.

17. The adjustable splash guard of claim 11 wherein said second fastener further comprises a slot at one end for removing said fastener from a secured position between said mud flap and adjustable cover.

18. The adjustable splash guard of claim 12 wherein said plurality of variable positioning apertures adjacently arcuately located through said first and second sides of said mud flap further comprises a center of said adjacently arcuately located positioning apertures defined by said pivoting connection.

19. A method of securing an adjustable splash guard to a vehicle, the method comprising the steps of:
securing a first end of an adjustable cover having an inside panel and an outside panel forming a pocket therebetween to a substantially planer mud flap defined by first and second sides at a pivot point using a first fastener; and
rotatably adjusting a second end of said adjustable cover about said pivot point to align a second fastener coupled to said inside panel of said adjustable cover to a select one of a plurality of variable positioning apertures located through said mud flap with said second fastener, said plurality of variable positioning apertures located within an elongated slot extending between said first and second sides of said mud flap, the adjustable cover being configured to rotate about the pivot point in an axial direction towards a portion of the vehicle.

20. The method of claim 19 further comprising the step of securing said adjustable splash guard to a vehicle by using a plurality of fasteners passing through said mud flap and said vehicle such that said adjustable cover is located in said select one of a plurality of variable positioning apertures located through said mud flap with a second fastener such that said adjustable cover seamlessly engages a body panel on said vehicle.

21. The method of claim 20 wherein said a bottom end of said mud flap is substantially parallel with the ground when said adjustable splash guard is secured to said vehicle.

22. The adjustable splash guard of claim 11, further comprising locating indicia corresponding to each aperture in said variable positioning apertures for facilitating the location of the adjustable cover relative to the mud flap for each option and/or side associated with the vehicle in which the adjustable splash guard is to be installed.

23. The adjustable splash guard of claim 1, wherein the elongated slot is positioned such that first and second ends of the slot are arcuate towards a portion of the vehicle.

24. The adjustable splash guard of claim 1, wherein the plurality of apertures are located on a profile of the mud flap.

25. The adjustable splash guard of claim 11, wherein the elongated slot is positioned such that first and second ends of the slot are arcuate towards a portion of the vehicle.

26. The adjustable splash guard of claim 11, wherein the plurality of apertures are located on a profile of the mud flap.

27. The method of claim 19, wherein the elongated slot is positioned such that first and second ends of the slot are arcuate towards a portion of the vehicle.

28. The method of claim 19, wherein the plurality of apertures are located on a profile of the mud flap.

29. An adjustable splash guard assembly comprising:
a substantially planer mud flap defined by first and second sides;
an adjustable cover having an inside panel and an outside panel forming a pocket therebetween;
an adjustable assembly comprising a pivoting connection formed by a first fastener coupling said inside panel of said adjustable cover to said mud flap, the adjustable assembly further comprising a selectively pivoting connection formed by a second fastener coupled to inside panel of said adjustable cover and a plurality of variable positioning apertures located through said mud flap, said plurality of variable positioning apertures located within an elongated slot extending between said first and second sides of said mud flap, the adjustable cover being configured to rotate about the pivot connection formed by the first fastener in an axial direction towards a portion of a vehicle, said plurality of positioning apertures being located on a profile of the mud flap, said plurality of variable positioning apertures being adjacently arcuately located through said first and second sides of said mud flap, said planer mud flap and said adjustable cover being made from different materials, said planer mud flap being made from a material having a first durometer and said adjustable cover being made from a second material having a second durometer such that said first durometer of said first material is higher than the durometer of said second material, said pivoting connection allowing said adjustable cover having first and second ends to be selectively rotatably connected by said first fastener at said first end such that said second end rotates along one of first and second sides of said mud flap allowing said second fastener to pass through a selected one of said plurality of variable positioning apertures located through said mud flap, said adjustable cover being rotatably coupled by said pivoting connection to one of said first and second sides, said mud flap further comprising a recess located on the other of said first and second sides of said mud flap for protectively shrouding said first fastener, said adjustable cover being rotatably coupled by said pivoting connection to one of said first and second sides, said mud flap further comprising a recess located on the other of said first and second sides of said mud flap for protectively shrouding said second fastener, said first fastener being molded into said adjustable cover, said second fastener further comprising a slot at one end for removing said fastener from a secured position between said mud flap and adjustable cover, said plurality of variable positioning apertures being adjacently arcuately located through said first and second sides of said mud flap further comprising a center of said adjacently arcuately located positioning apertures defined by said pivoting connection.
